(19) United States
(12) Patent Application Publication
(10) Pub. No.: US 2005/0080670 A1
(43) Pub. Date: Apr. 14, 2005

(54) Book recommendation cards and database

(76) Inventor: Thomas David Kehoe, Boulder, CO (US)

Correspondence Address: Thomas David Kehoe, P.O. Box 7551, Boulder, CO, 80306-7551, US

(21) Appl. No.: 10/686,266

(22) Filed: Oct. 14, 2003

(51) Int. Cl. G06F 17/60

(52) U.S. Cl. 705/14

(57) ABSTRACT

A set of postcards bound into book (or packaged with a CD or DVD) encouraging a reader to recommend the book to friends, and enabling the reader to register the book with publisher, and a computer database system for the publisher to reward and/or remunerate the reader for recommending the book to friends, and to enable the publisher to evaluate the effectiveness of marketing campaigns.

### BACKGROUND OF THE INVENTION

The present invention relates to printed matter, and more particularly to books and bookselling (Class 283/63.1).

Books are publicized to readers in a variety of ways, including book reviews, author interviews on radio and television, author readings at bookstores, advertising, etc. However, the most effective method of publicizing books remains word of mouth.

The Internet bookseller Amazon has pioneered new ways to publicize books. Most successful is their “Associates” program (http://www.amazon.com/associates). 900,000 Amazon Associates recommend their favorite books on their websites. In return, Amazon gives Associates a 5% sales commission. This helps Amazon sell millions of books, while providing income to Associates. Associates include individuals as well as institutions such as libraries and public radio stations. Amazon's computer technology is new but beneath it all is old-fashioned “word of mouth.”

Amazon Associates sell millions of books each year, but far more books are sold when readers simply tell their friends about a book they like. Publishers may be grateful to such readers, and might be willing to pay such readers a sales commission, but publishers have no way to identify such readers. A need exists for a simple, easy to use method and system that encourages readers to recommend books to their friends, and enables publishers to identify and remunerate such readers.

Publishers also give away dozens, often hundreds of free books for promotional purposes. Publishers stamp such books “Review Copy-Not For Sale” or a similar message. Scrupulous used booksellers, including Amazon, forbid the sale of such promotional copies. Many newspapers and magazines have ethics policies forbidding employees from selling promotional items. However, promotional copies inevitably turn up for sale by used booksellers. Publishers would benefit from a way to trace back such illicit copies to identify the book reviewer or other person who sold the book to the used bookseller.

### BRIEF SUMMARY OF THE INVENTION

Generally speaking, in accordance with the Invention, a combination of cards bound into books and a computer database system to track such cards is provided.

Accordingly, it is an object of the Invention to encourage readers to recommend favorite books to friends and acquaintances.

It is another object of the Invention to enable publishers to remunerate readers who recommend books to friends and acquaintances.

It is another object of the Invention to enable publishers to identify readers who recommend books to friends and acquaintances, and use this information to improve marketing programs.

Still other objects and advantages of the invention will, in part, be obvious and will, in part, be apparent from the specification.

The invention accordingly comprises the features of construction, combinations of elements and arrangements of parts which will be exemplified in the constructions hereinafter set forth, and the scope of the invention will be indicated in the claims.

### BRIEF DESCRIPTION OF THE DRAWINGS

FIG. 1 shows the front of a card that enables readers to register their books and the back of the cards a reader gives to friends.

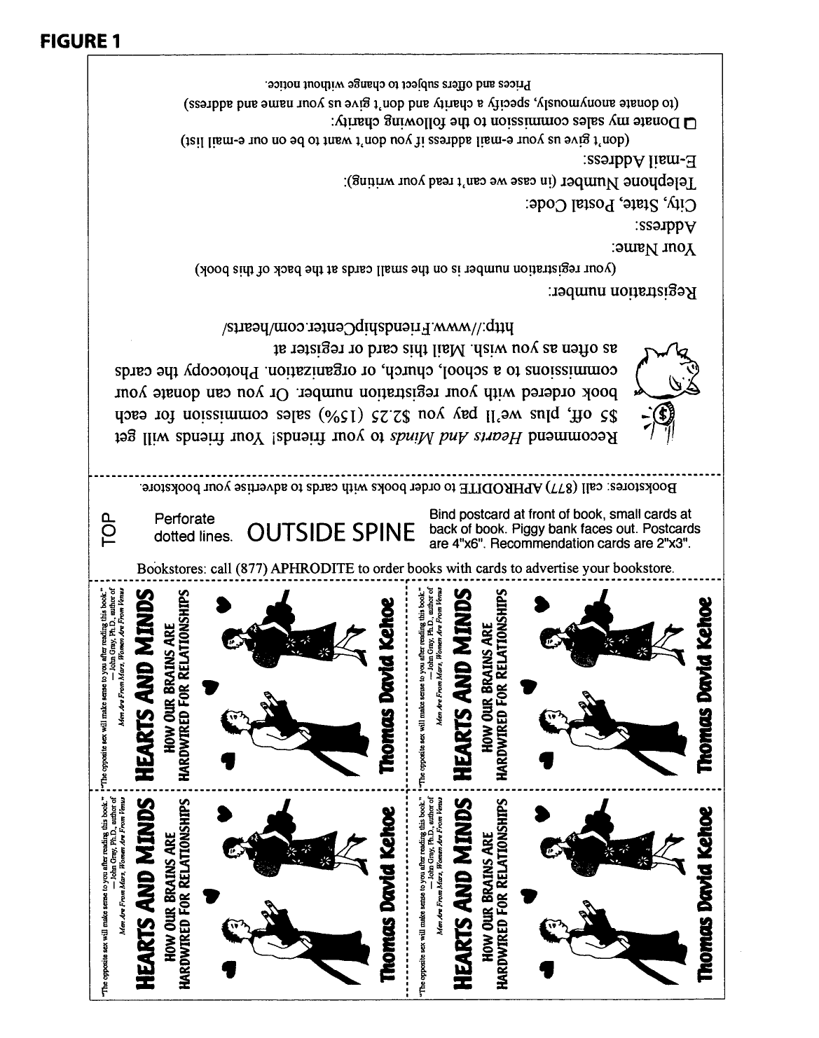

FIG. 2 shows the back of a card that enables readers to register their books and the front of the cards a reader gives to friends.

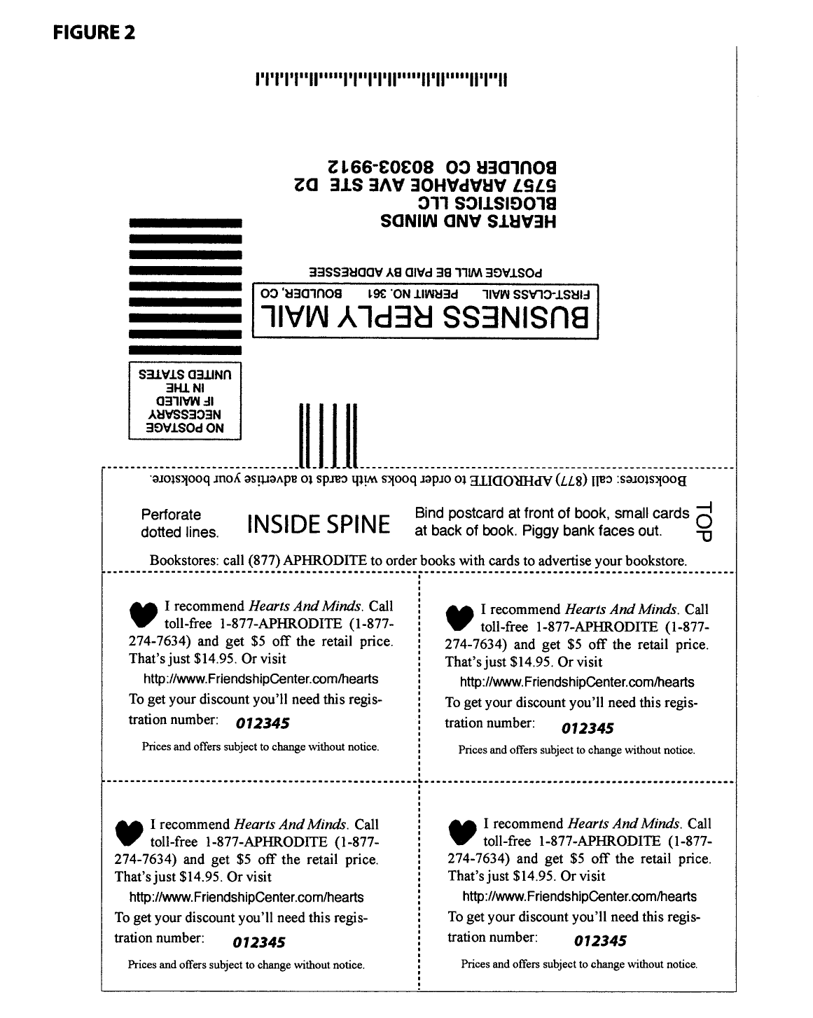

FIG. 3 shows the front of a card that enables readers to recommend a book to their friends, and encourage the friends to order the book from a bookstore.

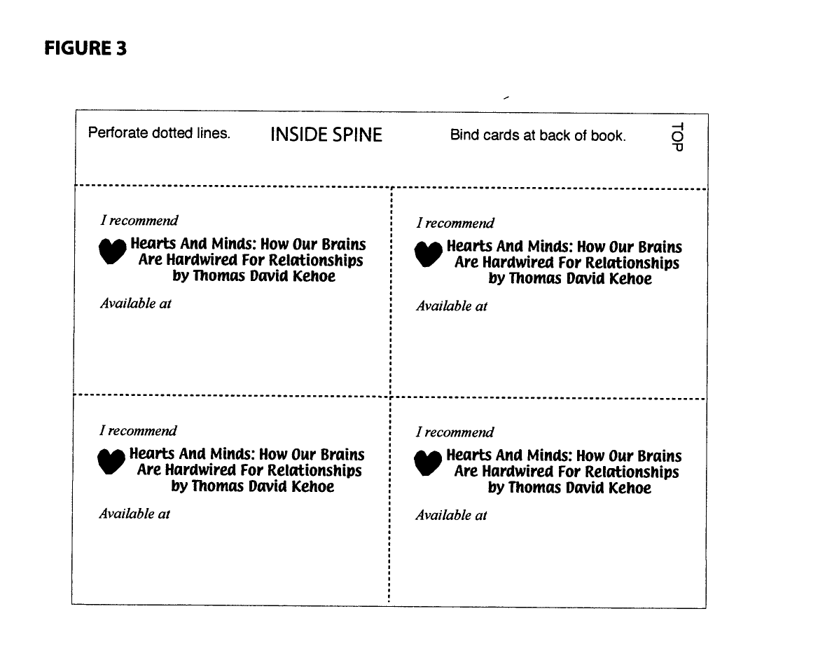

FIG. 4 shows the back of a card that enables readers to recommend a book to their friends, and encourage the friends to order the book from a bookstore.

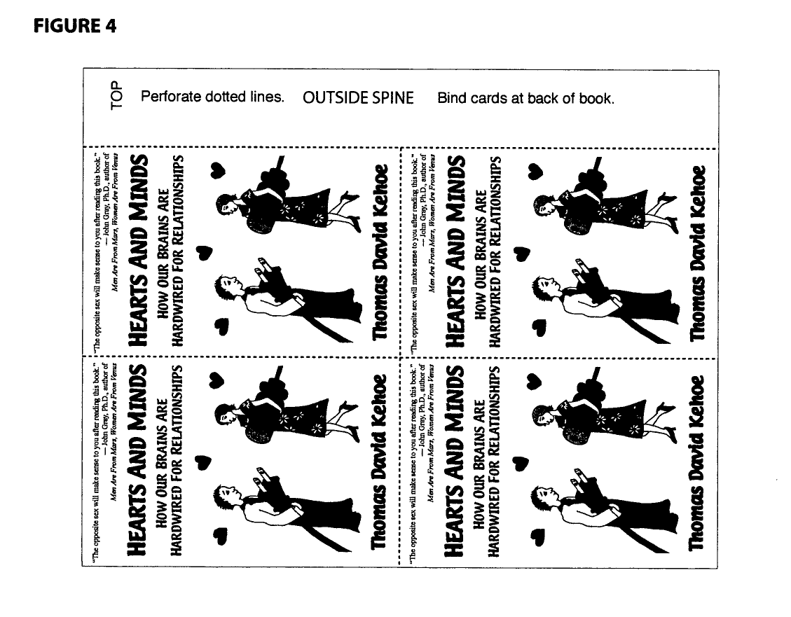

### DETAILED DESCRIPTION OF THE PREFERRED EMBODIMENTS

In the first configuration of the Invention, two postcard-sized (six inches by four inches) cards are bound into a book. The cards are most easily bound into the book between the back cover and text pages, or between the front cover and the text pages.

The first card explains to the reader that he or she will receive a sales commission (typically 15%) for recommending the book to his or her friends. This card also explains that the friends will receive a discount (typically $5) when ordering the book from the publisher (or from a fulfillment house representing the publisher).

The first card also suggests that reader can specify a charity that the publisher will donate the sales commission to, if the reader doesn't wish to receive a sales commission (or if the reader doesn't wish to identify himself or herself to the publisher).

The first card also suggests that the reader can photocopy the second cards as often as he or she wishes, or e-mail the information on the cards to many friends.

The first card has spaces for the reader to fill in his or her name and address. This card also has a space to write the serial number from the second cards. This serial number could be pre-printed on the first card, but this introduces the possibility of mixing up matched first and second cards when binding the books. To eliminate such errors, the serial number is printed only on the second cards, and the reader is expected to copy the serial number from the second cards to the first cards.

The first card also lists a website where the reader can register his or her book electronically, instead of mailing the card. Readers outside the United States may prefer this option, to save paying for postage.

Lastly, the converse side of the first card has the publisher's address and pre-paid postage indicia. This enables the reader to simply drop the card in the mail. The card is perforated for easy removal from the book.

The second cards are actually four business-sized (three inches by two inches) cards, perforated for easy separation. The second cards say “I recommend” and the title of the book. The second cards are intended for the reader to give to friends and acquaintances. The cards inform the friends that they will receive a discount (typically $5) when ordering the book from the publisher. The cards then provide the publisher's telephone number and website for ordering.

The second cards also have a serial number. Direct mailing services can easily print serial numbers using inkjet printers. The same serial number is printed on all four business-sized cards.

Lastly, the converse side of the second card shows a small version of the book's cover.

After the readers mail their cards to the publisher, the publisher enters the data into a relational database. The database has fields for each reader's name, address, telephone number, and e-mail address. Other fields store the book title (or ISBN number) and the serial number of the reader's book.

A second, related database stores the invoices for books sold. This database has similar fields for the name, address, etc. of the person buying the book. In addition, an optional field stores the serial number used to order the book (and receive a discount). This is the serial number of the book owned by the person who recommended the book.

The second database can also have a field for the serial number of the book being shipped out. This is less important and introduces the possibility of error when matching invoices and books. To reduce such errors, it's better not record the serial of the book on the invoice.

At certain intervals (e.g., monthly) the publisher runs several reports from the two related databases. The first report lists the number of books shipped that were ordered using the same serial number. This report enables the publisher to pay readers who recommend a book to their friends.

A second report ranks the readers in order of number of referral sales. The publisher may then contact the top readers and ask what they did to recommend the book. E.g., the publisher may discover that a hair stylist recommended a book to fifty clients. The publisher then markets the book to other hair stylists. Or the publisher may see that the top sellers are in a certain city or state, and plan an author book tour in that region.

A publisher may also record the serial numbers of books sent out. E.g., a publisher is considering sending free copies of a book to psychologists. The publisher has a choice of buying mailing lists from several psychology associations and journals. Each mailing has thousands of addresses. The publisher “tests the waters” by sending out one hundred copies to a sample of each database. The publisher records the serial numbers of each set of books, and then later runs a database report to see which mailing list produced the most referral sales.

A publisher might also record the serial numbers of promotional books mailed out, e.g., to book reviewers. When used books stamped “Review Copy—Not For Sale” appear in bookstores, the publisher checks the serial numbers on the list and contacts the recipient to inquire as to how a promotional copy got into a used bookstore. For example, I traced a promotional copy of a book sold on Amazon to a magazine publisher. The magazine publisher assured me that their book reviewers never sold promotional copies and that this copy must have been taken from their dumpster by a scavenger. The magazine publisher profusely apologized and offered to promote the book on their website, even though their reviewers had chosen not to review the book.

This configuration of the Invention could also be used to promote compact disk (CD) music recordings and digital video disk (DVD) recordings of movies.

In the second configuration of the Invention, a single card (approximately six inches by four inches) is bound into a book, usually between the back cover and text pages. This card is divided into four small cards (approximately three inches by two inches), perforated for easy separation.

These cards say “I recommend” and the title of the book. The cards are intended for the reader to give to friends and acquaintances. The cards then say “Available at” and have a blank space for bookstores to rubberstamp their addresses.

The converse side of these cards show a small version of the book's cover.

No computer database is necessary for the second configuration of the Invention.

The new technology that makes this Invention useful isn't fully described in the above paragraphs. The real technological advances are in printing, such as Xerox Docutech “print on demand” systems that enables small publishers to print small quantities of books easily and cheaply; and the Internet (including Amazon), which enables small publishers to promote specialized books to niche markets.

These new technologies have engendered many small publishing companies. According to Bowker's Books in Print, there are 73,000 publishers in the United States. 11,000 new publishing companies start each year. This figure grows 30% annually.

At the same time, the percentage of books sold in bookstores is dropping, and is now well below 50%.

Big, traditional publishers would not find this Invention useful. They sell books through bookstores. Their books are stocked in all mainstream bookstores. They don't want to sell books via readers calling a fulfillment house, as this would anger bookstores. Readers can recommend a traditional publisher's book without saying where to buy the book, because the book will be available in almost any bookstore.

In contrast, small publishers can't get their books into bookstores. Small publishers prefer to sell directly to readers, skipping the distributors, wholesalers, jobbers, retailers, etc. that take most of the money readers pay for books. Small publishers usually publish niche books, where “word of mouth” marketing is most effective. This Invention is most useful for small, niche publishers; who use novel technologies such as “print on demand” and Internet marketing; and this Invention is not obvious to anyone familiar with how traditional book marketing.

Thus, by utilizing the above construction, a combination of cards bound into books and a computer database for improving “word of mouth” promotion of books is realized.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative, and not in a limiting sense.

It will also be understood that the following claims are intended to cover all of the generic and specific features of the invention, herein described, and all statements of the scope of the invention which, as a matter of language, might be said to fall therebetween.

1. Bound printed matter including media that
a) encourages a reader of said bound printed matter to recommend said bound printed matter to one or more other persons, and
b) said media enables said reader to register said bound printed matter with said bound printed matter's publisher, and
c) is printed with a unique alphanumeric identifier.

2. Bound printed matter and media according to claim 1, in which said media and bound printed matter are one or more postcards bound into a book.

3. Media according to claim 2, in which said media includes a postcard with form spaces for said reader's name and address, and said unique alphanumeric identifier, and a pre-printed address for mailing said postcard to said publisher.

4. A computer database system which enables said publisher to reward said reader for recommending said bound printed matter according to claim 1.

5. A reward according to claim 6, in which said reward is remuneration.

6. A computer database system, according to claim 4, which enables said publisher to evaluate the effectiveness of marketing programs.

7. Media according to claim 1, in which said media offers a reward to said person(s) to whom said bound printed matter is recommended.

8. A reward according to claim 7, in which said reward is a lower price to buy said bound printed matter.

9. Sound recording media including media that
a) encourages a listener to said sound recording media to recommend said sound recording media to one or more other persons, and
b) said media enables said reader to register said sound recording media with said sound recording media's publisher, and
c) is printed with a unique alphanumeric identifier.

10. Sound recording media and media according to claim 9, in which said media and sound recording media are one or more postcards packaged with a compact disk (CD).

11. Media according to claim 10, in which said media includes a postcard with form spaces for said reader's name and address, and said unique alphanumeric identifier, and a pre-printed address for mailing said postcard to said publisher.

12. A computer database system which enables said publisher to reward said reader for recommending said sound recording media according to claim 9.

13. A reward according to claim 12, in which said reward is remuneration.

14. Media according to claim 9, in which said media offers a reward to said person(s) to whom said sound recording media is recommended.

15. Video recording media including media that
a) encourages a viewer to said video recording media to recommend said video recording media to one or more other persons, and
b) said media enables said reader to register said video recording media with said video recording media's publisher, and
c) is printed with a unique alphanumeric identifier.

16. Video recording media and media according to claim 15, in which said media and video recording media are one or more postcards packaged with a digital video disk (DVD).

17. Media according to claim 16, in which said media includes a postcard with form spaces for said reader's name and address, and said unique alphanumeric identifier, and a pre-printed address for mailing said postcard to said publisher.

18. A computer database system which enables said publisher to reward said reader for recommending said video recording media according to claim 15.

19. A reward according to claim 18, in which said reward is remuneration.

20. Media according to claim 15, in which said media offers a reward to said person(s) to whom said video recording media is recommended.
